(19) United States
(12) Patent Application Publication
(10) Pub. No.: US 2002/0120721 A1
(43) Pub. Date: Aug. 29, 2002

(54) Client capability detection in a client and server system

(75) Inventors: Bernd Eilers, Hamburg (DE); Thorsten Laux, Hamburg (DE)

Correspondence Address: SONNENSCHEIN NATH & ROSENTHAL, P.O. BOX 061080, WACKER DRIVE STATION, CHICAGO, IL, 60606-1080, US

(73) Assignee: Sun Microsystems, Inc.

(21) Appl. No.: 10/027,409

(22) Filed: Dec. 20, 2001

(30) Foreign Application Priority Data
Dec. 22, 2000 (EP) 00128221.9

(51) Int. Cl. G06F 15/16; G06F 15/177

(52) U.S. Cl. 709/220; 709/203; 709/218

(57) ABSTRACT

Methods, systems, and articles of manufacture consistent with the present invention provide a data from a server to a client via a network, where it is determined to send the data to the client, a client information is obtained from the client based on the determination, and after obtaining the client information, the data is sent to the client.

### CROSS-REFERENCE TO RELATED APPLICATIONS

This Application claims priority to the filing date of the following foreign patent application, which is incorporated herein by reference:

European Patent Application No. 00128221.9, entitled “CLIENT CAPABILITY DETECTION IN A CLIENT AND SERVER SYSTEM”, filed Dec. 22, 2001.

### FIELD OF THE INVENTION

The present invention relates to client/server data processing environments, and in particular, the invention relates to a server detecting a client's capabilities.

### BACKGROUND OF THE INVENTION

Computers have been used for a wide range of applications, for example, ranging from simple editing of text documents to complex distributed processing applications involving a large number of distributed data processing systems and involving the transfer of data between the data processing systems.

With a growing number of data processing systems having access to computer networks (e.g. local area networks, world-wide networks, company-wide intranets, and the Internet), a growing number of applications are offered that accommodate a plurality of data processing systems. Such applications may be, for example, found in the field of home banking, office applications, remote e-mail applications, or supercomputing applications. In such data communications systems, high speed links via, for example, permanent connections, circuit-switched connections, or packet-switched connections, are used to exchange digital data at high speed (i.e., high bit-rates) such that even graphics data or data from moving images can be exchanged among the data processing systems.

It is a typical feature of such data communications systems that not all participating data processing units are required to have the same powerful processing capability. That is, a main computer having powerful computing facilities can service a number of smaller sub-computers through one or more communication links. Since the smaller sub-computers are typically assigned the tasks of accessing the main computer and requesting processing facilities or data from the main computer, while the main computer sends the data to the small sub-computers, the main computer is often referred to as a server (or server unit) and the small sub-computers are referred to as clients (or client units). In such a client/server environment, a client may request the execution of an application program by the server, and may receive a data processing result from the server via the network or the communication link connecting the client and the server.

Further, data communication systems are known where a plurality of clients can connect to a portal to execute applications. A portal may be a large site in a network including a plurality of servers, which provides a variety of services including, for example, office applications, searching functions, news functions, e-mail applications, discussion groups, on-line shopping, and links to other sites on the network. A portal may thus be a general-purpose site offering the capability to perform applications on behalf of a client or assisting a client in executing an application.

Generally, in a client/server or portal scenario, the server may be a large computing device that has the resources to store and execute application programs, which are used to provide service to a client. Since the application programs and sufficient computing power are generally available at the server side, the client may be a data processing system with less powerful computing resources functioning as an interface to receive user commands required to request the execution of a desired application program by the server. In other words, the client transmits commands to the server, and receives and, possibly, displays computation results from the server.

A typical data communication system 10 is shown in FIG. 1. In FIG. 1, a server 12 and clients 14a, 14b, 14c, 14d, . . . , 14n communicate through communication links 16, possibly through an intranet 18 or the Internet 20.

FIG. 2 shows a block diagram of a typical server 12 and a typical client 14. Server 12 and client 14 communicate through communication link 16 connected to a respective interface 22a and 22b, respectively. FIG. 3 shows an example of operations performed by the client side and the server side for the typical client/server environment of FIG. 1. The client side refers to client 14 and the server side refers to server 12.

For example, in case a user at the client side wishes to access a document from server 12 (e.g. a web-page available at server 12 or another location), the user first selects a program 24 (e.g., a browser), which is located on the client 14, to access the document. The program 24 is run on a client processor 26 (step 301). When the user clicks on a particular place on the client display 28, a content data request unit 30 sends a content data request to server 12 to request the document (step 302). According to the Internet protocol, such a request message can typically be an HTTP message for requesting the transfer of web pages from a database 32 located within server 12 (or located elsewhere outside the server). The HTTP-request includes the URL (i.e., the network address) from which the web pages should be retrieved, and some header information.

After setting up communication link 16 between client 14 and server 12, a request message reception unit 34 at server 12 receives the content data request message (step 303). Alternatively, client 14 can also request the execution of processing programs 36, which are also known as servlets, by server 12.

Then, server 12 can analyze the content data request message (step 304). Step 304 is optional and will be described below.

Then, a server processing unit 38 either statically or dynamically retrieves the requested content data (e.g., the web pages) (step 305). In a static retrieval, the server processing unit SPM-A accesses a local database DB-A and retrieves the web pages. In a dynamic retrieval, server processing unit SPM-A can run additional programs, such as servlets, in order to retrieve data from a remote site in a dynamic manner.

Then, server 12 can adapt the retrieved data (step 306). Step 306 is optional and will be described below.

Then, a content data providing unit 40 of server 12 provides the retrieved content data (e.g., the web page) to the client via communication link 16 (step 307). The content data is then received by client 14 (step 308). Then, program 24 provides the user at the client side with the options to display the content data on display 28 or to send the transferred content data to a disc (not shown) or a printer (not shown) (step 309). If the requested content data are web-pages, typically, complete data sets relating to a web page are requested by client CU-A and transferred to the client side.

Then, request unit 30 determines whether the user requires further pages from server 12 (step 310). If the user requires further pages as determined in step 310, then the process returns to step 302 to send a request for content data to server 12. If the user does not require further pages as determined in step 310, then the link is closed, for example, by stopping the browser (step 311). Thus, display frames for local viewing at the client side can be transmitted from server 12 to client 14, where the user can view the desired web pages.

In the above description, request unit 30 is described as sending a content data request to server 12, however, request unit 30 can send more complex operation commands to server 12 in a similar manner. For example, in case where the client wishes to scroll through a document, request unit 30 receives a corresponding input command from the browser and transmits the command via communication link 16 to server 12. In turn, server 12 prepares a corresponding display content for transfer to client 14 in order to enable client 14 to locally display the changed display content. Similarly, in a case where the user wishes to edit the document, request unit 30 could transmit respective commands from client 14 to server 12, which will accordingly be processed at server 12. Changed display contents (content data) are then transmitted to client 14 for local display.

It is also possible, however, that server 12 does not have the required resources to provide a desired service, but client 14 may already have the required resources to provide the service. For example, client 14 may have resources to render drawings or to edit a data file, while server 12 may not have such resources. Corresponding application programs may thus be available at both the client side (e.g., an applet) and the server side (e.g., a servlet) for performing a desired operation, i.e., providing a desired service. Such programs are also available as one of the programs 24 shown in client 14 in FIG. 2.

Since, on the client side different browsers or different processing programs 24 can be executed, the server side must have knowledge about what type of program is run on the client side, in order to determine in which manner the retrieved web pages should be provided back to client 14. This functionality is illustrated in steps 304 and 306 of the flowchart shown in FIG. 3. In step 304, server 12 analyzes the request message (e.g., an HTTP message) in order to retrieve information about client 14, such as an identification of the type of browser used by client 14. In step 306, server 12 then partially adapts the retrieved data for client 14. For example, server 12 can detect from the request message that client 14 is a WAP mobile telephone and may thus conclude that this type of client 14 has no graphics facilities such that only non-graphics data is provided back to client 14.

However, in typical data communication systems, a limited amount of information can be obtained by analyzing the request message. In principle, the typical information that can be obtained is the type of browser and generally no other information is transferred, in particular no information, for example, about the settings of the programs. That is, although the above described functionality of steps 304, 306 in FIG. 3 allows server 12 to provide a certain amount of adaptation to client 12, there are a plurality of options or preferences which the user can set when executing the browser program on the client side, which options and preferences server 12 cannot obtain.

Furthermore, client 14 itself may have certain processing facilities or processing capabilities about which information is not generally and automatically sent to server 12 in request messages. For example, client 14 may have such client characteristics as being provided with a powerful color display, thereby allowing sophisticated graphics data to be provided to client 14. In other words, client 14 may comprise a plurality of client characteristics, where client specific information identifies these client characteristics (such as, information on the processing capabilities of client 14 and client-set information set by client 14 during the running of content data requesting unit 30), while this information about client 14 is not typically detectable at server 12 from a request message conventionally sent from client 14 to server 12.

Based on the above-described problems of data communication systems, it is therefore desirable to improve them.

### SUMMARY OF THE INVENTION

Methods, systems, and articles of manufacture consistent with the present invention provide a server with the ability to detect the capabilities of a client on demand. This ability is provided to the server either by the server sending a request for client information to the client and the client responding with client information, or executing an information gathering program on the client, which sends client information back to the server. Accordingly, the server is able to tailor data that is to be sent to the client to meet the client's capabilities. For example, when a client requests the download of a web page from a server, the server can tailor the web page to meet the client's capabilities by first obtaining information on the client's capabilities. The server can obtain this information on demand by prompting the client to send the server information about the client. The client capability information can then be stored at the server for future reference.

In accordance with methods consistent with the present invention, a method in a data processing system comprising a web server having a web page with a content is provided. The method comprises the steps of: determining to download the web page to a client; obtaining a client capability responsive to the determination; adapting the content of the web page to be compatible with the obtained client capability; and downloading the web page with the adapted content to the client.

In accordance with articles of manufacture consistent with the present invention, a computer-readable medium is provided. The computer-readable medium contains instructions that cause a data processing system comprising a web server having a web page with a content to perform a method comprising the steps of: determining to download the web page to a client; obtaining a client capability responsive to the determination; adapting the content of the web page to be compatible with the obtained client capability; and downloading the web page with the adapted content to the client.

In accordance with systems consistent with the present invention, a data processing system is provided. The data processing system comprises: a secondary storage device having a stored web page with a content; a memory comprising a computer program that determines to download the web page to a client; obtains a client capability responsive to the determination; adapts the content of the web page to be compatible with the obtained client capability; and downloads the web page with the adapted content to the client; and a processing unit that runs the computer program.

In accordance with systems consistent with the present invention, a data processing system for providing a web page with a content to a client is provided. The data processing system comprises: means for determining to download the web page to the client; means for obtaining a client capability responsive to the determination; means for adapting the content of the web page to be compatible with the obtained client capability; and means for downloading the web page with the adapted content to the client.

In accordance with articles of manufacture consistent with the present invention, a computer-readable memory device encoded with a data structure and a program that accesses the data structure is provided. The program is run by a processor in a system comprising a web server having a web page with a content. The data structure has a plurality of entries, each entry comprising: a client capability, wherein the program updates the client capability responsive to a client requesting to download the web page from the server, the content of the web page being adapted to be compatible with the client capability.

The above-mentioned and other features, utilities, and advantages of the invention will become apparent from the following detailed description of the preferred embodiments of the invention together with the accompanying drawings.

Other systems, methods, features, and advantages of the invention will become apparent to one with skill in the art upon examination of the following figures and detailed description. It is intended that all such additional systems, methods, features, and advantages be included within this description, be within the scope of the invention, and be protected by the accompanying drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 depicts a block diagram of a typical client/server based data processing system;

FIG. 2 depicts a block diagram of a typical client and a typical server;

FIG. 3 depicts a flow diagram illustrating the steps for transferring content data from a typical server to a typical client;

FIG. 4 depicts a block diagram of a client/server based data processing system with which embodiments of the present invention may be implemented;

FIG. 5 depicts a block diagram of a server with which embodiments of the present invention may be implemented;

FIG. 6 depicts a block diagram of a data structure with which embodiments of the present invention may be implemented;

FIG. 7 depicts a block diagram of a client with which embodiments of the present invention may be implemented;

FIG. 8 depicts a flow diagram illustrating the steps for determining client characteristics in accordance with methods, systems, and articles of manufacture consistent with the present invention;

FIG. 9 depicts a flow diagram illustrating the steps for transferring content data from the server to the client in accordance with methods, systems, and articles of manufacture consistent with the present invention;

FIG. 10 depicts a flow diagram illustrating alternative steps for determining client characteristics in accordance with methods, systems, and articles of manufacture consistent with the present invention; and

FIG. 11 depicts a flow diagram illustrating further alternative steps for determining client characteristics in accordance with methods, systems, and articles of manufacture consistent with the present invention.

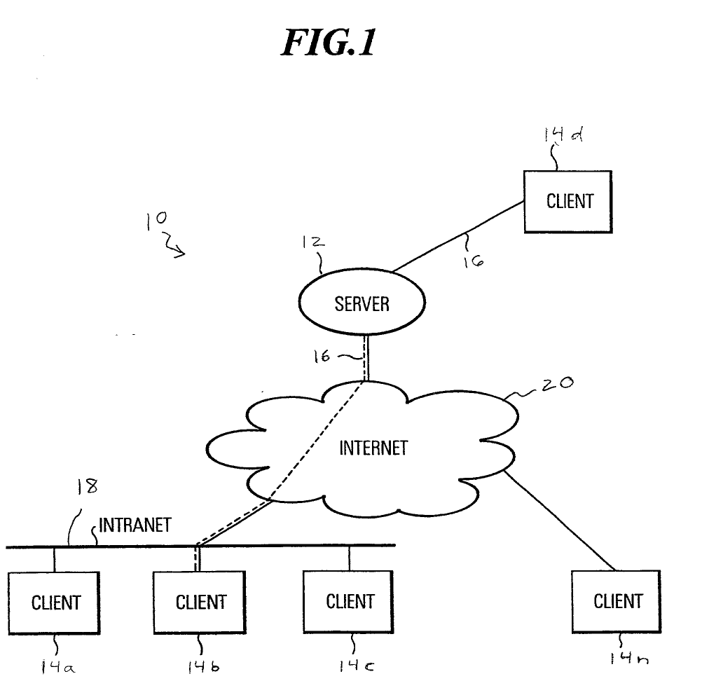

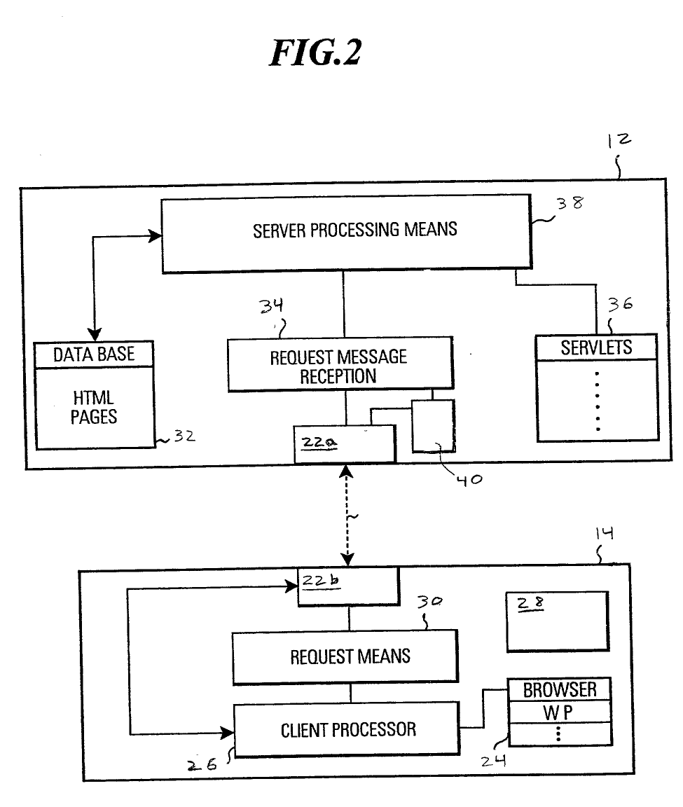

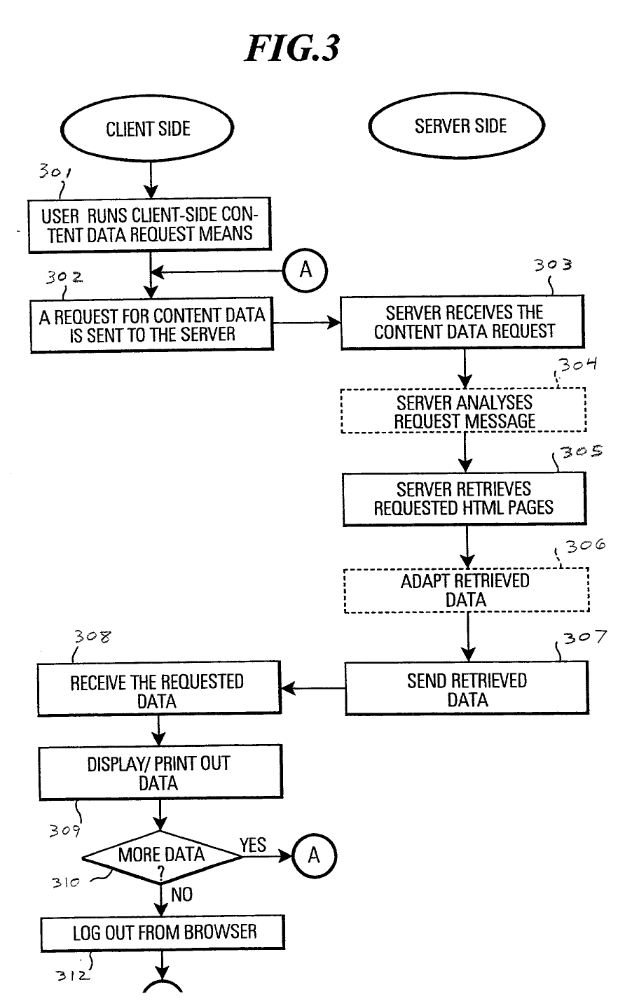

### DETAILED DESCRIPTION OF THE INVENTION

Reference will now be made in detail to an implementation consistent with the present invention as illustrated in the accompanying drawings. Wherever possible, the same reference numbers will be used throughout the drawings and the following description to refer to the same or like parts.

In accordance with methods, systems, and articles of manufacture consistent with the present invention, a server is able to detect the capabilities of a client on demand. This ability is provided to the server either by the server sending a request for client information to the client and the client responding with client information, or executing an information gathering program on the client, which sends client information back to the server. Accordingly, the server can adapt data that is to be sent to the client to meet the client's capabilities. For example, when a client requests the download of a web page from a server, the server can adapt the web page to meet the client's capabilities (e.g., the client's video display capabilities) by first obtaining information on the client's capabilities. The server can obtain this information on demand by prompting the client to send the server information about the client. The client capability information can then be stored at the server for future reference.

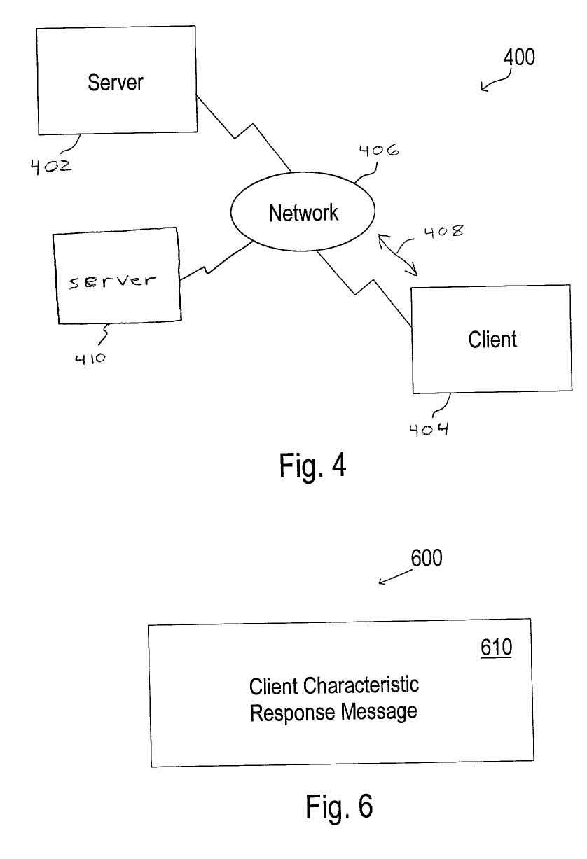

FIG. 4 depicts a block diagram of a client/server based data processing system 400 with which methods, systems, and articles of manufacture consistent with the present invention may be implemented. A client computer system 404 (“the client”) and a server computer system 402 (“the server”) are each connected to a network 406, such as a Local Area Network, Wide Area Network, or the Internet. The client is illustrated as communicating with the server, as indicated by arrow 408. As will be described below, the server can communicate with the client, for example, for receiving and transmitting content data. The client can transmit to the server an expression requesting the transmission of content data, such as a web page, and the server can transmit the requested content data to the client. Data processing system 400 can comprises a plurality of servers, which are similar to server 402, such as server 410. Similar to server 402, server 410 can communicate with client 404 and with server 402, and other servers, via network 406.

FIG. 5 depicts a block diagram of the server. Server 402 comprises a central processing unit (CPU) 502, an input output I/O unit 504, a memory 506, a secondary storage device 508, and a video display 510. The server may further comprise standard input devices such as a keyboard, a mouse, or a speech processing means (each not illustrated). The server may be, for example, a web server.

Server secondary storage 508 has stored thereon a database 512 with content data, such as web pages.

Server memory 506 contains a request message reception program 514, one or more servlets 516, a content data providing program 518, and a client characteristics determination program 520. The client characteristics determination program 520 comprises an exploration request transmission program 522, a response message reception program 524, a client characteristic information storage program 526, and a request message analyzing unit 528.

In summary, the request message reception program 514 receives content data messages from the client. The one or more servlets 516 are application programs (e.g., a word processor program) on the server. The content data providing program 518 provides data retrieved from server secondary storage 508 to the client.

The client characteristics determination program 520 determines client characteristic information (CCI) about the client. The client characteristics determination program 520 comprises the exploration request transmission program 522 for sending a client characteristics exploration message (CC-RQ) to the client. The client characteristics exploration message requests information about the client. Furthermore, the client characteristics determination program 520 comprises the response message reception program 524 for receiving a client characteristics response message (CC-RM), which includes client characteristics information (CCI) about the client and which is sent by the client in response to the client characteristics exploration request (CC-RQ) as transmitted by the exploration request transmission program 522. The client characteristics determination program 520 also comprises the client characteristic information storage program 526 for storing client characteristic information (CCI). Also, the client characteristics determination program 520 comprises a request message analyzing unit 528 for analyzing messages received by the server from the client.

Each of the above-described programs on the server will be described in more detail below. These programs may comprise or may be included in one or more code sections containing instructions for performing their respective operations. While these programs are described as being implementation as software, however, the present implementation may be implemented as a combination of hardware and software or hardware alone. Also, one of skill in the art will appreciate that these programs may comprise or may be included in a data processing device, which may be a server, communicating with server 402.

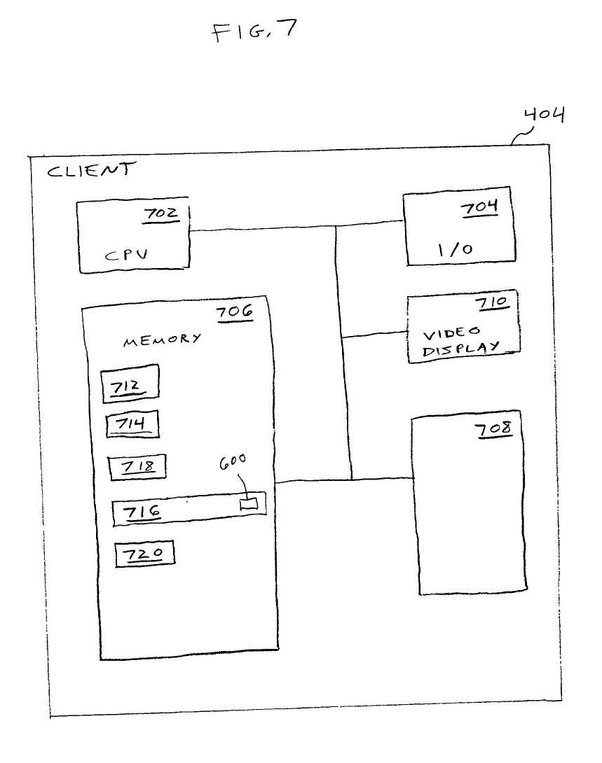

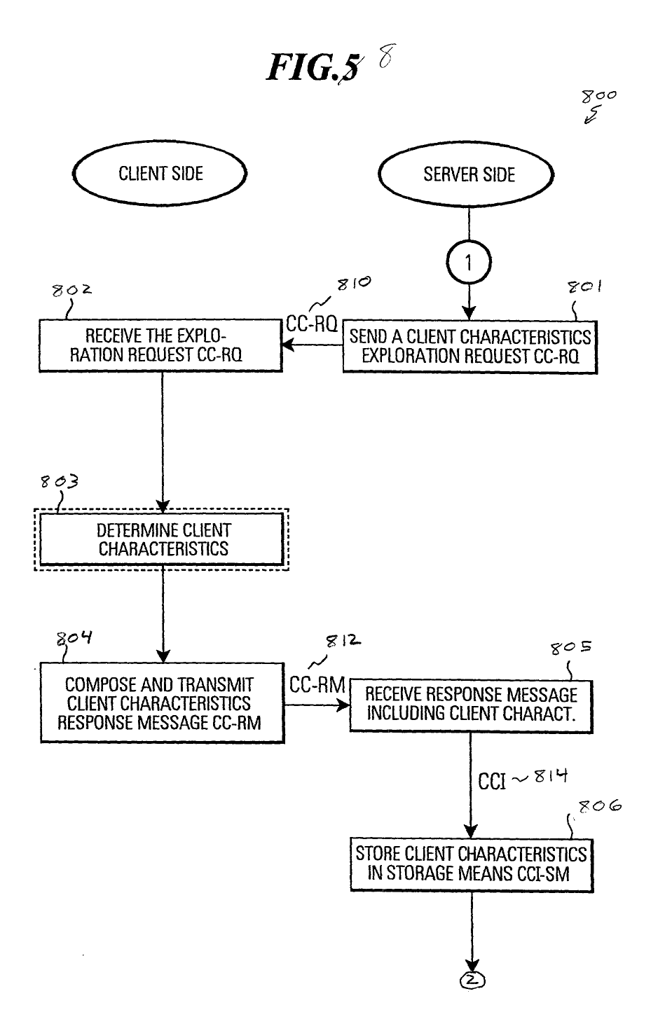

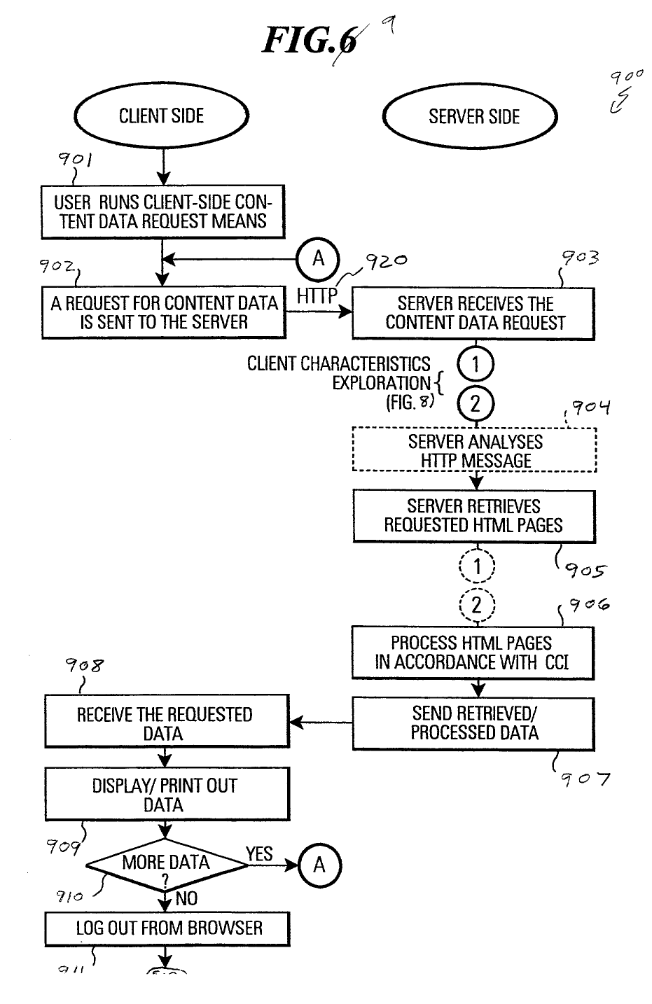

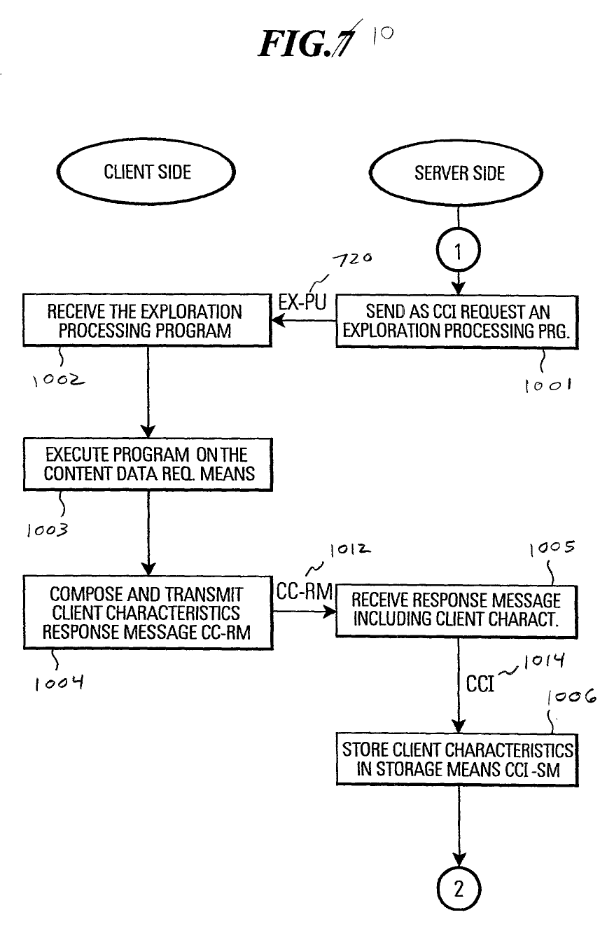

FIG. 7 depicts a block diagram of the client. Client 404 comprises a central processing unit (CPU) 702, an input output I/O unit 704, a memory 706, a secondary storage device 708, and a video display 710. The client may further comprise standard input devices such as a keyboard, a mouse, or a speech processing means (each not illustrated).

Client memory 706 contains a request program 712, one or more application programs 714 (e.g., a browser and a word processor), a client characteristic detection program 716, and a transmission/reception program 718.

In summary, the request program 712 sends content data requests to the server. The application programs can be one or more of, for example, a browser, a word processor, and a spreadsheet program. The client characteristic detection program 716 is similar to the client characteristic detection program 520 described above with respect to the server. The transmission/reception program 718 receives client characteristics exploration requests (CC-RQ) from the server and transmits client characteristic response messages (CC-RM) to the server.

Thus, as will be described in more detail below, the client transmission/reception program 718 receives a client characteristics exploration request (CC-RQ) from the server, the client characteristics determination unit 716 then determines a client characteristic information (CCI) in response to the received client characteristics exploration request (CC-RQ), and the response message transmitting unit 718 then transmits the client characteristics response message (CC-RM) to the server in response to the client characteristics exploration request (CC-RQ). For example, when the client receives an exploration request (CC-RQ) from the server requesting the video capabilities of the client, the client characteristics determination unit 716 determines the client video capabilities. These video capabilities are sent as client characteristic information (CCI) to the server via the response message transmitting unit 718 in a client characteristics response message (CC-RM).

In other words, the client provides desired client characteristic information (CCI) to the server in response to a request for that information from the server. The client characteristics exploration message (CC-RQ) can be a request to transfer all the client characteristics available on the client to the server unit. Accordingly, the client characteristics determination unit 716 on the client-side then provides all the available client characteristics to the server. However, the client characteristics exploration request (CC-RQ) may alternatively contain specific parameters indicating specific client characteristics to be explored, in which case the client characteristics determination unit 716 of the client side will provide specifically desired client characteristics to the server.

Each of the above-described programs on the client will be described in more detail below. These programs may comprise or may be included in one or more code sections containing instructions for performing their respective operations. While these programs are described as being implementation as software, however, the present implementation may be implemented as a combination of hardware and software or hardware alone. Also, one of skill in the art will appreciate that these programs may comprise or may be included in a data processing device, which may be a server, communicating with client 404.

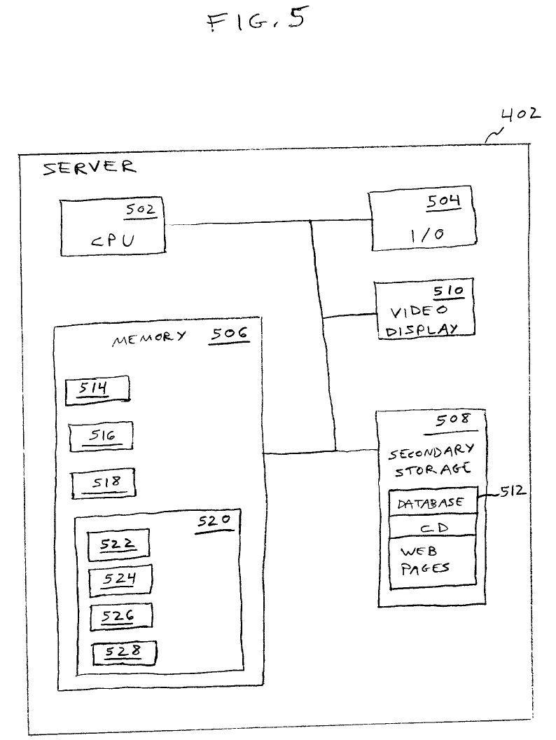

Client characteristic detection program 716 of the client includes a data structure 600 having entries reflecting generated client characteristic response messages (CC-RM). FIG. 6 depicts a more detailed diagram of data structure 600. The sample data structure 600 that is depicted in FIG. 6 represents a client characteristic response message. As will be described in more detail below, client characteristic detection program 716 of the client generates a client characteristic response message 610 based on a request for client characteristic information from the server.

Although aspects of one implementation are depicted as being stored in memory, one skilled in the art will appreciate that all or part of systems and methods consistent with the present invention may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of client-server based data processing system 400 have been described, one skilled in the art will appreciate that a data processing system suitable for use with methods, systems, and articles of manufacture consistent with the present invention may contain additional or different components. Also, the server computer system can serve a plurality of clients communicating with the server computer system.

FIG. 8 depicts a flow diagram 800 illustrating exemplary steps for determining client characteristic information in accordance with methods, systems, and articles of manufacture consistent with the present invention. In FIG. 8, first, the exploration request transmission program 522 of the server transmits a client characteristic exploration request (CC-RQ) 810 to the client (step 801).

Then, the transmission/reception program 718 of the client receives the client characteristics exploration request (CC-RQ) (step 802).

Then, the client characteristics determination unit 716 on the client side determines client characteristic information (CCI) in response to the received client characteristics exploration request (CC-RQ) (step 803). As described above, the client characteristics exploration request (CC-RQ) can be, for example, a request to provide all the client characteristics available on the client to the server. Alternatively, the request (CC-RQ) can contain specific parameters or indications to instruct the client characteristics determination unit 716 of the client to collect information about specific client characteristics.

For example, the requested client characteristics can be a client-set information (CS-INFO) consisting of the set language, the set graphics mode, the sound reception mode, the help mode, the character type, the graphics color, or some other information from which is detectable about the client or what the user has set as preferences inside the browser for creating results.

Then, the client characteristic determination program 716 of the client composes a client characteristics response message (CC-RM), for example containing the above mentioned information, by incorporating in a transmission message information about the determined client characteristics (step 804). Furthermore, in step 804, the client transmission reception program 718 transmits to the server the generated client characteristics response message (CC-RM) 812, including the determined client characteristics information (CCI).

Then, the response message reception program 524 of the server receives the client characteristics response message (CC-RM) containing the requested client characteristics information (CCI) 814 from the client (STEP 805).

The server can actively explore the client by sending and receiving the above-described request and response messages (CC-RQ) and (CC-RM), respectively. Thus, after executing step 805 on the server side, the server has its desired (or full) knowledge of the client characteristics. Therefore, the server then has available information indicating what a client is capable of and, for example, what the user has set as preferences inside the browser for creating results. The server can then process, evaluate, and use this client characteristics information.

The client characteristics determination program 520 of the server comprises the client characteristics information storage program 526 for storing the client characteristics information (CCI) contained in the response message (CC-RM). Therefore, the client characteristics information storage program 526 then stores the client characteristics information (CCI) (step 806) in, for example, secondary storage 512. Thus, the server can later perform some processing evaluation or analysis of the client characteristics information (CCI) stored in secondary storage 512.

Referring to FIG. 9, the server can, for example, use the client characteristics information (CCI) in a scenario where the client has requested content data (e.g., a web page) from the server. In the process 900 illustrated in FIG. 9, the process 800 of FIG. 8 is inserted between points (1) and (2). As shown, the process 800 of FIG. 8 can also be inserted between steps 905 and 906, as indicated with the dashed lines in FIG. 9.

In FIG. 9, first, the user selects program 714 (e.g., the browser), which is located on the client, to access the document (e.g., the web page). Program 714 is run on the client processor 702 (step 901). When the user clicks on a particular place on the client display 710, the content data request unit 712 of the client sends a content data request to the server (step 902). According to the Internet protocol, such a request message can be an HTTP message for requesting the transfer of web pages from the database 512 located on the server (or located elsewhere outside the server). The HTTP-request includes the URL (i.e. the network address) from which the web pages should be retrieved, and some header information.

The request message reception unit 514 of the server receives the content data request message 920 (step 903). Alternatively, the client can request the execution of processing programs 516, which are also known as servlets, by the server.

Then, process 800 of FIG. 8 is performed to explore the client's characteristics, as described above.

Then, the server can analyze the content data request message 920 (step 904). One of skill in the art will appreciate that step 904, as well as, other steps in the illustrated flow diagrams can be optional.

Then, the data content providing program 518 of the server provides the data content requested in the request message 920 (step 905). The data content providing unit 518 can also process the retrieved content data in accordance with the client characteristics information (CCI), which has been stored by the client characteristics storage program 526 (step 906). For example, if the client characteristics response message (CC-RM) contains two parameters, one indicating the type of client device and the other indicating the type of set graphics mode (e.g., large screen or small screen), then such a processing could for example result in a more specific information “the device is a device manufactured by XXX company” or “the device generally conforms to YYY standard”.

The processing in step 906, can for example be the following: if the analyzed and processed client characteristics information indicates “the client device generally conforms with YYY standard”, then the server can decide that it is appropriate to retrieve pages (content data) relating to “YYY standard” pages. Alternatively, the server may decide that it can read data of “ZZZ standard” but that the retrieved data must first be converted from ZZZ to YYY standard.

Then, the data content providing unit 518 of the server provides to the client the retrieved content data as processed in accordance with the client characteristics information (CCI) (step 907). Then, the client unit processing unit 702 receives the processed content data from the server (step 908).

Then, program 714 provides the user at the client with the options to display the content data on display 710 or to send the transferred content data to a disc (not shown) or a printer (not shown) (step 909).

Then, request unit 712 determines whether the user requires further pages from the server (step 910). If the user requires further pages as determined in step 910, then the process returns to step 902 to send a request for content data to the server. If the user does not require further pages as determined in step 910, then the link is closed, for example, by stopping the browser (step 911).

As described above, the client characteristics information (CCI) used for processing the retrieved data (e.g., the web page) in the step 906 is the client characteristics information which has been retrieved in the client characteristics exploration process 800 of FIG. 8. However, the client characteristics determination unit 520 also comprises the request message analyzing unit 528, which can detect a minimum client characteristic from analyzing, for example, the request message 920. Therefore, the processing of the retrieved data, in the step 906, can be performed on the basis of client characteristics information (CCI) obtained through the client characteristic exploration process 800 of FIG. 8 in combination with the client characteristics information (CCI) obtained from analyzing a request message 920 or any other command or other type of message sent by the client, in step 904. Both types of client characteristics information (CCI) are stored by the client characteristics storage program (CC-SM). The request message analyzing unit 528 can analyze the request message 920, for example, by analyzing a header information part of the request message 920 (i.e. the URL). For example, the request message 920 may be analyzed to result in a client characteristics of “client unit runs browser XYZ” while the additional client characteristics retrieved with the analysis indicate “browser has set the option: no colour data”, then the two pieces of information can be used in combination in order to result in the sending of data specially adapted (retrieved and modified) to the XYZ type client and without color. Thus, it is advantageous to evaluate the request message characteristics together with the analyzed client characteristics.

As explained above, the client characteristics exploration process 800 of FIG. 8 can be inserted between steps 903, 904 in FIG. 9. This has the advantage that the data content providing unit 518 can make a pre-selection (filter) of some web pages when collecting the data in step 905. That is, based on the client characteristics (CCI), the content data providing unit 518 can decide on the appropriate location for web pages to be retrieved or can inhibit the retrieval of web pages if the client unit does not have processing capabilities suitable for a particular kind of data. For example, if the result of the client characteristics exploration process 800 of FIG. 8 is that the client does not support an appropriate graphics mode, then web graphics pages will not be retrieved by the content data providing unit 518. Therefore, by inserting the client characteristics exploration process 800 of FIG. 8 before step 904, this allows to use the processing and computing power of the server unit for such types of data that can later be handled by the client. However, one of skill in the art will appreciate that the client characteristics exploration process 800 can be located anywhere before step 907 in FIG. 9.

As described above, the client characteristics exploration request (CC-RQ) can be a request instructing the client to provide all possible client characteristics. In that case, one request is made. However, the client characteristics exploration request (CC-RQ) can also contain one or more client exploration parameters (EXP-PARA) indicating the characteristics of the client to be explored, wherein the client characteristics response message (CC-RM) contains the client characteristics information (CCI) indicated by the client exploration parameters (EXP-PARA). In this manner, the client characteristics determination unit 520 of the server can pre-specify that it wants to obtain information about specific client characteristics. For example, if the data content providing unit 518 has detected during a retrieval of a web page that some specific client characteristic will be necessary for processing this type of data, such as moving images, then the client characteristics exploration process 800 of FIG. 8 may be carried out, for example between steps 905 and 906 of FIG. 9, in order to explore a specific client characteristic regarding the support for moving images. If the response message (CC-RM) then indicates that this specific client characteristic is missing (not supported by the client), there is no need for transferring this type of data to the client.

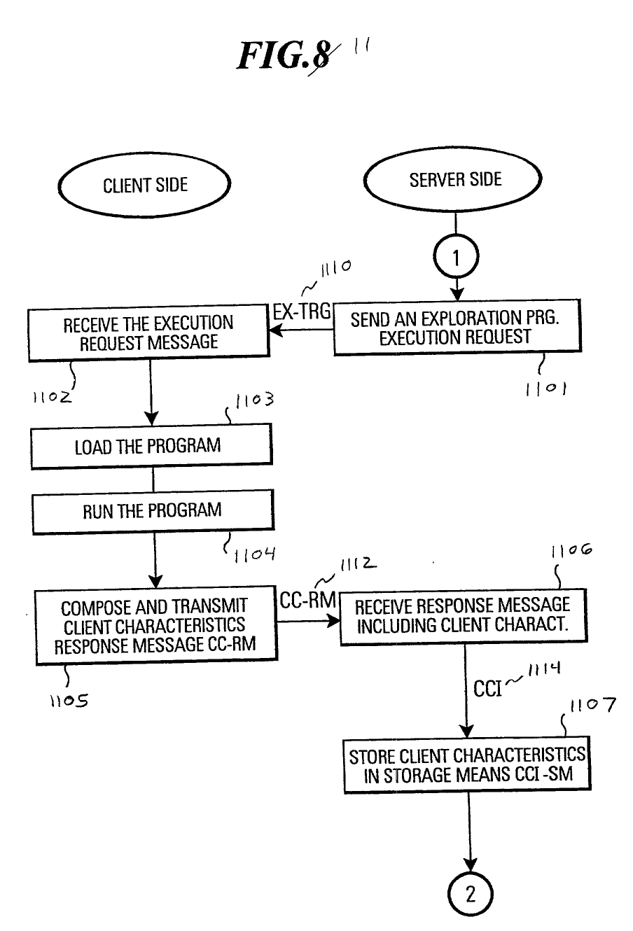

The client characteristics exploration process, which is described above with reference to process 800 of FIG. 8, can alternatively comprise process 1000 of FIG. 10 or process 1100 of FIG. 11, as described below. Accordingly, process 1000 of FIG. 10 or process 1100 of FIG. 11 can replace process 800 of FIG. 8 in process 900 of FIG. 9. In other words, process 1000 of FIG. 10 or process 1100 of FIG. 11 can be inserted, for example, between steps 903 and 904 of FIG. 9.

FIG. 10 depicts a flow diagram of a client characteristics exploration process 1000 that can replace process 800 of FIG. 8. In FIG. 10, first, the exploration request transmission unit 522 of the server sends to the client an exploration processing program unit 720, as opposed to a client characteristics exploration request (CC-RQ) of process 800 (step 1001). Then, the transmission/reception program 718 of the client receives the exploration processing programming unit 720 (step 1002). The client comprises, in the client characteristics determination unit 520, an exploration processing program execution unit constituted by the client processor 702. The received exploration processing program unit 720 for collecting the desired client characteristics is then executed by the processor 702 (step 1003). Similar to process 800 of FIG. 8, the request means 712 then composes the collected client characteristics into a response message (CC-RM), which are then transferred to the server (step 1004). The exploration response receiver 524 of the server then receives the response message (CC-RM) including the client characteristics (step 1005). Then, the client characteristics storage program 526 can store the client characteristics (step 1006). Thus, the transmission and the execution of an explorer processing program acts as a kind of processing program for spying on the client to extract its client characteristics. An example of this is described below.

Servers and clients can be configured to run browser programs (e.g., data content requesting units) which use SCRIPT language programs. This being the case, a browser program has a scripting unit and, when the server sends to the client the SCRIPT program together with an HTML page which includes this script code, the included script code can immediately be run by the scripting unit on the browser program. An example of such script language programs are the JAVAScript program language or the VirtualBasicScriptProgram language, which can be sent together with content data in the form of web pages to the client. The common characteristics of all these types of SCRIPT programs is that they can be immediately run after the web page is transferred to the client. Sun, Sun Microsystems, the Sun logo, and Java are trademarks or registered trademarks of Sun Microsystems, Inc. in the United States and other countries. All other company and product names may be trademarks of their respective companies.

FIG. 11 depicts a flow diagram of a client characteristics exploration process 1100 that can also replace process 800 of FIG. 8. In FIG. 11, first, the exploration request transmission program 522 sends an exploration processing program unit execution request (EX-TRG) 1110 as a client characteristics exploration request (CC-RQ) to the client (step 1101). That is, rather than the exploration request transmission program EXPX transmitting a complete exploration processing programming unit 720 (as in process 1000 of FIG. 10), the execution request (EX-TRG) can merely request the execution of a desired program residing at the client side. The transmission/reception program 718 of the client then receives the request (EX-TRG) (step 1102).

Then, an exploration processing program unit 720 indicated by the execution request (EX-TRG) is loaded in the client (step 1103) and the loaded exploration processing program unit 720 in the client is run in response to the execution message (EX-TRG) from the server (step 1104). When the program unit 720 has already been loaded in the client, step 1103 can be omitted.

Similar to process 800 of FIG. 8, the request means 712 then composes the collected client characteristics into a response message (CC-RM), which are then transferred to the server (step 1104). The exploration response receiver 524 of the server then receives the response message (CC-RM) 1112 including the client characteristics (step 1106). Then, the client characteristics storage program 526 can store the client characteristics (CCI) 1114 (step 1107).

The following example illustrates how the server can explore the client by transmitting an exploration program execution request (EX-TRG) 1110. Typically, on a browser there is an option to use a plug-in program with which the browser capabilities can be expanded. If the plug-in program has already been loaded when running the browser, then the execution request (EX-TRG) will merely trigger the execution of the plug-in program. Thus, the plug-in program is the exploration processing program unit 720 triggered by the execution request (EX-TRG). One example of such a plug-in program is the RVP plug-in made by Sun Microsystems, Inc. as described in European Patent Application No. 00 100 739.2, filed during August 2000.

Another example of an exploration processing program unit triggered for execution with the transmitted execution request (EX-TRG) is an applet, which is a typical JAVA application program running on the client. Accordingly, any of the JAVAScript program, the plug-in, and the applet program units can be used for exploring, in the client, the client characteristics to be transferred to the server.

One of skill in the art will appreciate that there is a variety of program units for exploring different types of client characteristics. For example, one exploration processing unit may just explore the hardware configuration of the client and provide the hardware configuration as client characteristics to the server. Different types of exploration processing units can be transferred to and are executable in the client depending on the desired client characteristics information. As another example, an exploration processing unit may explore the preferences or options set by the user on the browser program (i.e., content data requesting unit) when the browser program is executed. The type of processing and the type of program may be dependent on the desired client characteristics to be explored.

Generally, the client characteristics information (CCI) can comprise client-set information set by the client during the running of the content data requesting unit 712, or client specific information representing client characteristics information of the processing capabilities of the client. An example of the first category is the aforementioned setting of browser preferences. An example of the second category is the aforementioned hardware configuration.

The client-set information can include, for example, one or more characteristics selected from the group consisting of the set language, the set graphics mode, the sound reception mode, the help mode, the character type and the graphics color.

The client specific information can include, for example, one or more characteristics selected from the group consisting of the WML, WAP or HTML capabilities of the client, the screen size, the hardware terminal type, the terminal software, the OS name and version, information about the available software, supported script language, installed plug-ins, and running applets.

As described above, data processing system 400 can comprises a plurality of servers, such as server 410, similar to server 402. One or more of the servers can be a central repository storing the client characteristic information (CCI), as in step 806. This stored client characteristic information (CCI) is then accessed by the other servers of data processing system 400 as required. For example, server 410 can obtain client characteristics information (CCI) from client 404, as described above with respect to FIGS. 8, 10, and 11. Server 410 then has client characteristic information (CCI) related to client 404 stored in its secondary storage. After server 402 receives a request for content data, as in step 903 of FIG. 9, server 402 can retrieve desired client characteristic information (CCI) from server 410, instead of executing process 800 of FIG. 8 after step 903. Then, server continues execution of step 904 or 905, as described above. Further, after step 905, server 402 can again retrieve desired client characteristic information from server 410 between steps 905 and 906 of FIG. 9.

One of skill in the art will appreciate that many other client characteristics may be useful to explore and to transfer to the server on the basis of the teachings herein.

Further, the client can be one or more device selected from the group consisting of a personal computer, a mobile UMTS telephone, a car navigation system, and a laptop computer. As explained above, the server and the client can comprise processing units based on JAVA.

While reference is made above to special message exchanges between a client and a server in an Internet application example where web pages are retrieved from the server in a JAVA environment, one of skill in the art will appreciate that the present invention is not limited to the special JAVA data communication implementation.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the described implementation includes software but the present implementation may be implemented as a combination of hardware and software or hardware alone. The invention may be implemented with both object-oriented and non-object-oriented programming systems. The scope of the invention is defined by the claims and their equivalents.

What is claimed is:

1. A method in a data processing system comprising a web server having a web page with a content, the method comprising the steps of:
determining to download the web page to a client;
obtaining a client capability responsive to the determination;
adapting the content of the web page to be compatible with the obtained client capability; and
downloading the web page with the adapted content to the client.

2. The method of claim 1, further comprising the step of:
storing the obtained client capability at the web server.

3. The method of claim 1, wherein the step of obtaining the client capability comprises the steps of:
requesting the client capability from the client;
generating the requested client capability at the client; and
retrieving the generated client capability from the client.

4. The method of claim 3, wherein the requested client capability is generated by the client.

5. The method of claim 3, wherein the requested client capability is generated by a client information retrieval application program on the client.

6. The methods of claim 1, wherein the client capability is obtained from a secondary storage on the web server.

7. The method of claim 1, wherein the client capability is obtained from the client.

8. The method of claim 1, wherein the client capability is obtained from a second server.

9. The method of claim 1, wherein the client comprises a browser program, and wherein the client capability comprises a setting of the browser program.

10. The method of claim 1, wherein the client capability comprises a video display capability of the client.

11. A computer-readable medium containing instructions that cause a data processing system comprising a web server having a web page with a content to perform a method comprising the steps of:
determining to download the web page to a client;
obtaining a client capability from the client responsive to the determination;
adapting the content of the web page to be compatible with the obtained client capability; and
downloading the web page with the adapted content to the client.

12. The computer-readable medium of claim 11, further comprising the step of:
storing the obtained client capability at the server.

13. The computer-readable medium of claim 11, wherein the step of obtaining the client capability comprises the steps of:
requesting the client capability from the client;
generating the requested client capability at the client; and
retrieving the generated client capability from the client.

14. The computer-readable medium of claim 13, where in the requested client capability is generated by the client.

15. The computer-readable medium of claim 13, wherein the requested client capability is generated by a client information retrieval application program on the client.

16. The computer-readable medium of claim 11, wherein the client capability is obtained from a secondary storage on the web server.

17. The computer-readable medium of claim 11, wherein the client capability is obtained from the client.

18. The computer-readable medium of claim 11, wherein the client capability is obtained from a second server.

19. The computer-readable medium of claim 11, wherein the client comprises a browser program, and wherein the client capability comprises a setting of the browser program.

20. The computer-readable medium of claim 11, wherein the client capability comprises a video display capability of the client.

21. A data processing system comprising:
a secondary storage device having a stored web page with a content;
a memory comprising a computer program that determines to download the web page to a client; obtains a client capability responsive to the determination; adapts the content of the web page to be compatible with the obtained client capability; and downloads the web page with the adapted content to the client; and
a processing unit that runs the computer program.

22. The method of claim 15 wherein the client comprises a browser program, and wherein the client capability comprises a setting of the browser program.

23. The method of claim 15, wherein the client capability comprises a video display capability of the client.

24. A data processing system for providing a web page with a content to a client, the data processing system comprising:
means for determining to download the web page to the client;
means for obtaining a client capability responsive to the determination;
means for adapting the content of the web page to be compatible with the obtained client capability; and
means for downloading the web page with the adapted content to the client.

25. A computer-readable memory device encoded with a data structure and a program that accesses the data structure, the program is run by a processor in a system comprising a web server having a web page with a content, the data structure having a plurality of entries, each entry comprising:
a client capability, wherein the program updates the client capability responsive to a client requesting to download the web page from the server, the content of the web page being adapted to be compatible with the client capability.
